(19) United States
(12) Patent Application Publication
(10) Pub. No.: US 2019/0055753 A1
(43) Pub. Date: Feb. 21, 2019

(54) LUGGAGE LOCK

(71) Applicant: SINOX CO., LTD., New Taipei City (TW)

(72) Inventors: Yueh-Cheng Huang, New Taipei City (TW); Hao-Jhong Lyu, New Taipei City (TW); Chia-Wei Weng, New Taipei City (TW); Chia-Fang Yu, New Taipei City (TW)

(21) Appl. No.: 16/103,975

(22) Filed: Aug. 16, 2018

Related U.S. Application Data
(60) Provisional application No. 62/547,447, filed on Aug. 18, 2017.

(51) Int. Cl. E05B 65/52; E05B 35/10

(52) U.S. Cl. CPC E05B 65/52; E05B 35/105

(57) ABSTRACT

A luggage lock applied to lock luggage, including a first case body and a second case body, the luggage lock contains: a first lock body and a second lock body. The first lock body includes a first locking mechanism and is detachably locked on the first case body. The second lock body includes a second locking mechanism and is detachably locked on the second case body. First lock body and the second lock body are movably connected. When the first case body and the second case body are at a closed position, the first lock body and the second lock body lock the first case body and the second case body respectively at a locking position. The first lock body is unlocked using the first locking mechanism, the first case body is opened. The second lock body is unlocked using the second locking mechanism, the second case body is opened.

### FIELD OF THE INVENTION

The present invention relates to a luggage lock which is applied to lock a luggage.

### BACKGROUND OF THE INVENTION

Due to safety concern, airport security take luggage checks very serious as to protect passengers, staffs, airports and planes from accidental/malicious harm, crime and other threats. Sometime, the luggage lock will be broken and unusable, after customs officers break the luggage obligately to check object(s) in the luggage.

To solve above-mentioned problem, Travel Sentry developed many lock systems that is “accepted and recognized” by the TSA, and allows them, using special tools and codes, to open and re-lock locks. The lock system contains two locking units, one of which is used by user to lock/unlock the luggage, and the other locking unit is applied by custom officers to unlock/lock the luggage as checking the luggage and prevent the custom officers damaging the locks.

The present invention has arisen to mitigate and/or obviate the afore-described disadvantages.

### SUMMARY OF THE INVENTION

The primary aspect of the present invention is to provide a luggage lock which is applied to lock the luggage easily and securely.

To obtain above-mentioned aspect, a luggage lock provided by the present invention contains: a first lock body and a second lock body.

The first lock body includes a first locking mechanism configured to lock a first case body of a luggage.

The second lock body includes a second locking mechanism configured to lock a second case body of the luggage.

When the first case body and the second case body of the luggage are located at a closed position, the first lock body and the second lock body locks the first case body and the second case body respectively at a locking position.

When the first lock body is unlocked, the first case body is opened. When the second lock body is unlocked, the second case body is opened.

The first locking mechanism is a key lock or a combination lock.

The second locking mechanism is a key lock or a combination lock.

Thereby, when the first lock body is unlocked by the first locking mechanism, the first case body is opened so that object(s) can be taken out or placed into the luggage. When the second lock body is unlocked by the second locking mechanism, the second case body is opened so that object(s) can be taken out or placed into the luggage.

### BRIEF DESCRIPTION OF THE DRAWINGS

FIG. 1 is a schematic view showing the assembly of a luggage lock according to a first embodiment of the present invention.

FIG. 1A is a cross sectional view showing the application of the luggage lock according to the first embodiment of the present invention.

FIG. 2 is a schematic view showing the assembly of a luggage lock according to the second embodiment of the present invention.

FIG. 2A is a cross sectional view showing the application of the luggage lock according to the second embodiment of the present invention.

FIG. 3 is a schematic view showing the application of a luggage lock according to a third embodiment of the present invention.

FIG. 3A is a cross sectional view showing the application of the luggage lock according to the third embodiment of the present invention.

FIG. 4 is a top plan view showing the assembly of the luggage lock according to the fourth embodiment of the present invention.

FIG. 4A is a top plan view showing the application of the luggage lock according to the fourth embodiment of the present invention.

FIG. 5 is a schematic view showing the application of the luggage lock according to the fifth embodiment of the present invention.

FIG. 5A is a cross sectional view showing the application of the luggage lock according to the fifth embodiment of the present invention.

FIG. 6 is a schematic view showing the application of the luggage lock according to a sixth embodiment of the present invention.

FIG. 6A is a cross sectional view showing the application of the luggage lock according to the sixth embodiment of the present invention.

### DETAILED DESCRIPTION OF THE PREFERRED EMBODIMENTS

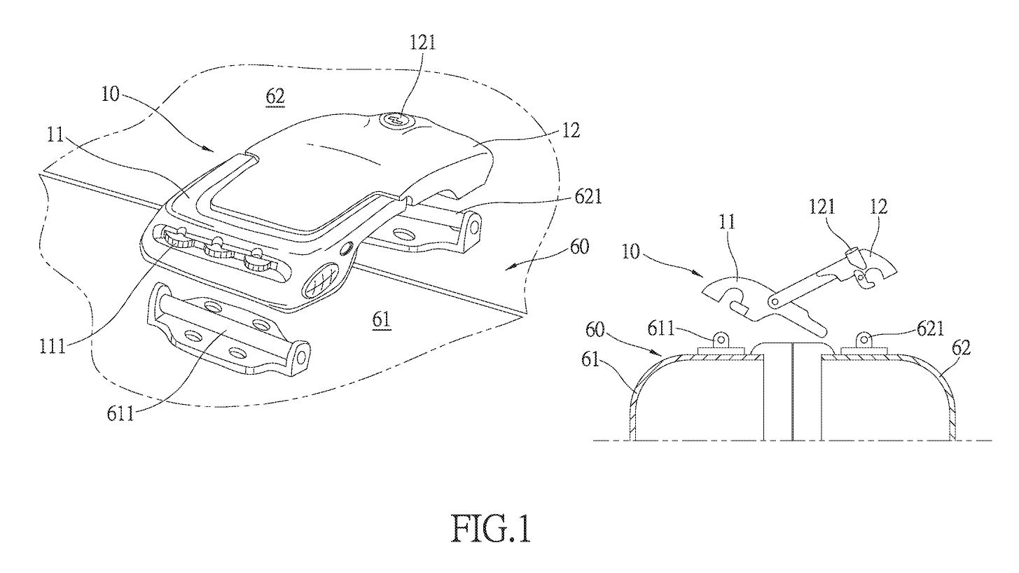

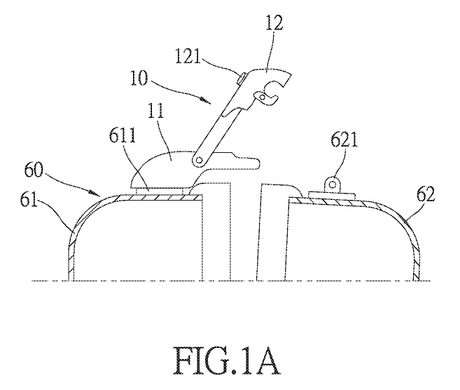

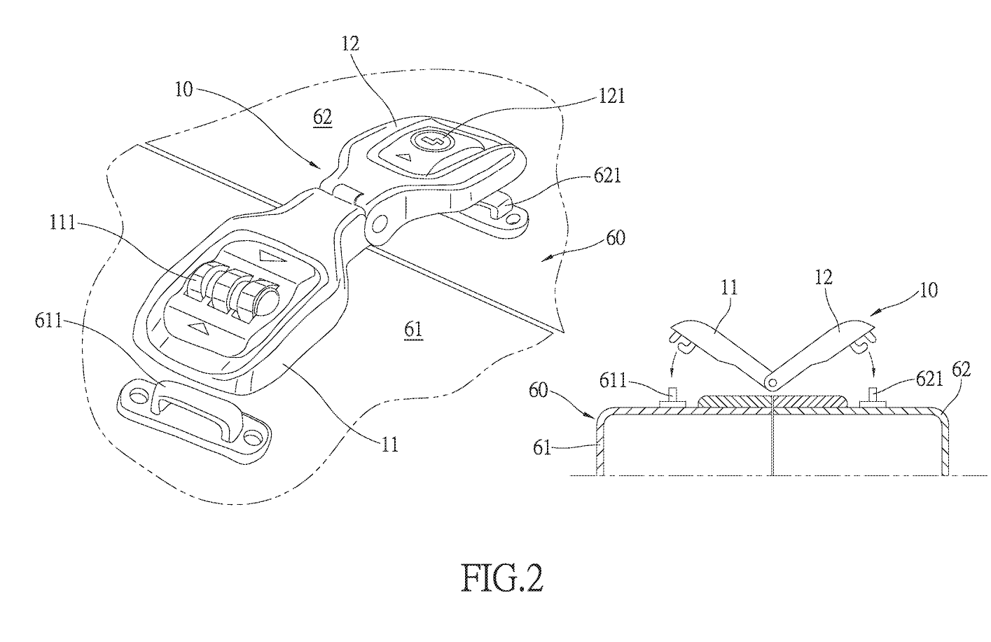

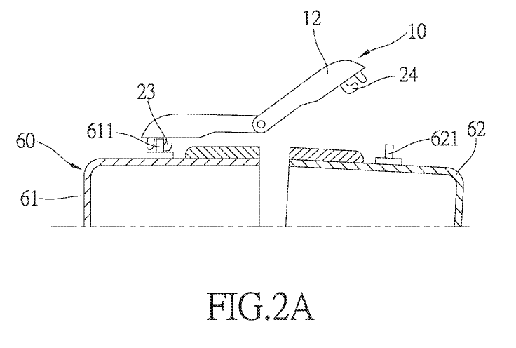

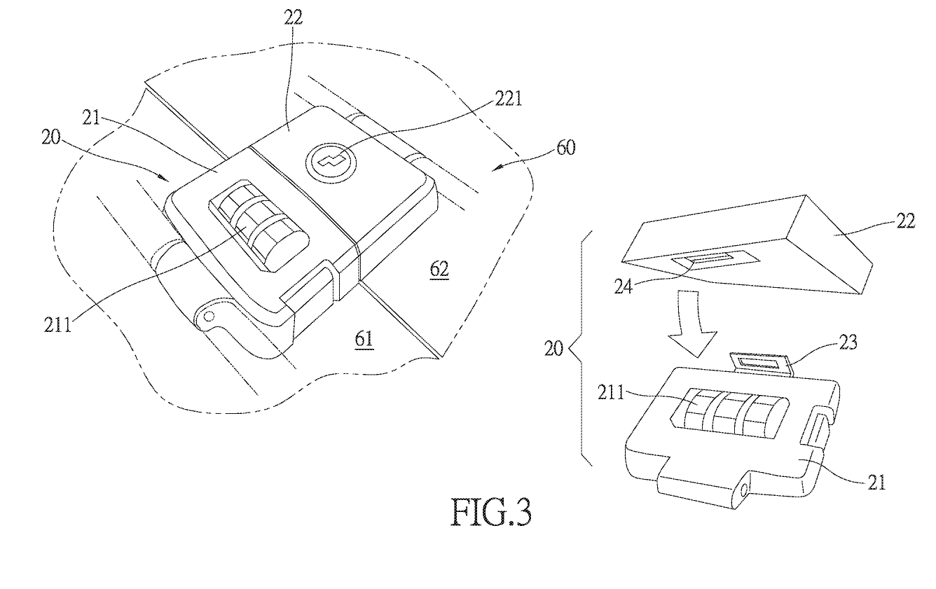

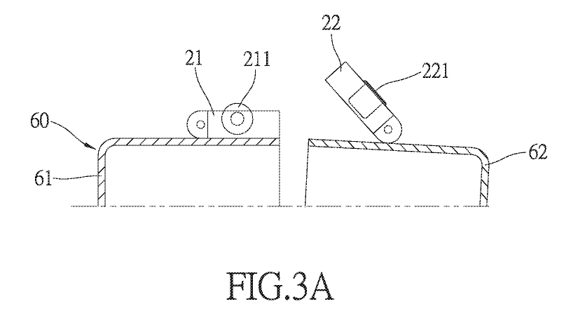

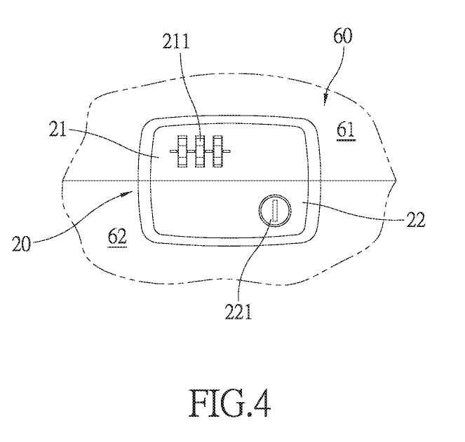

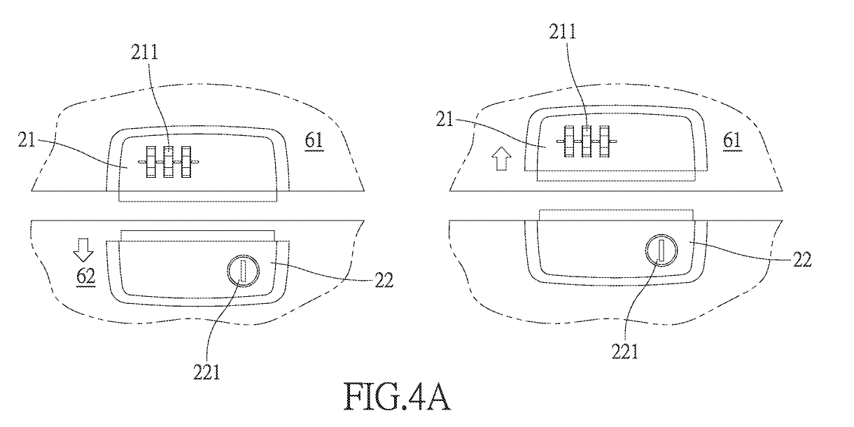

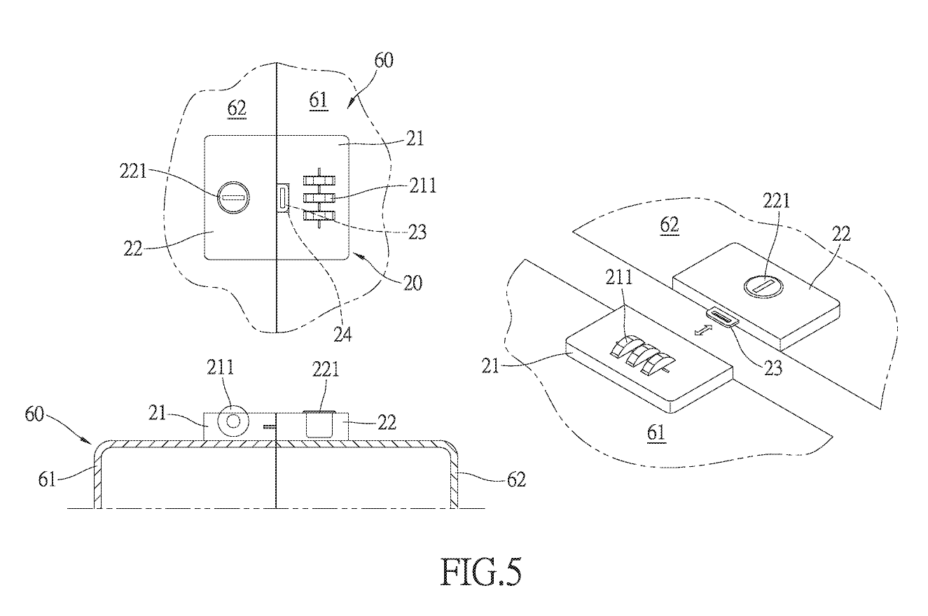

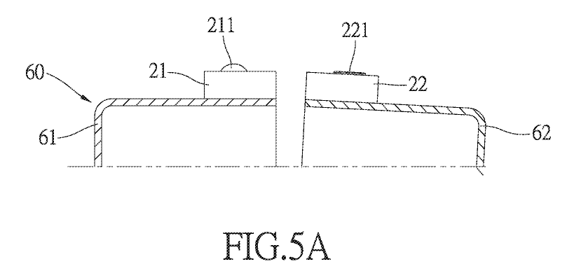

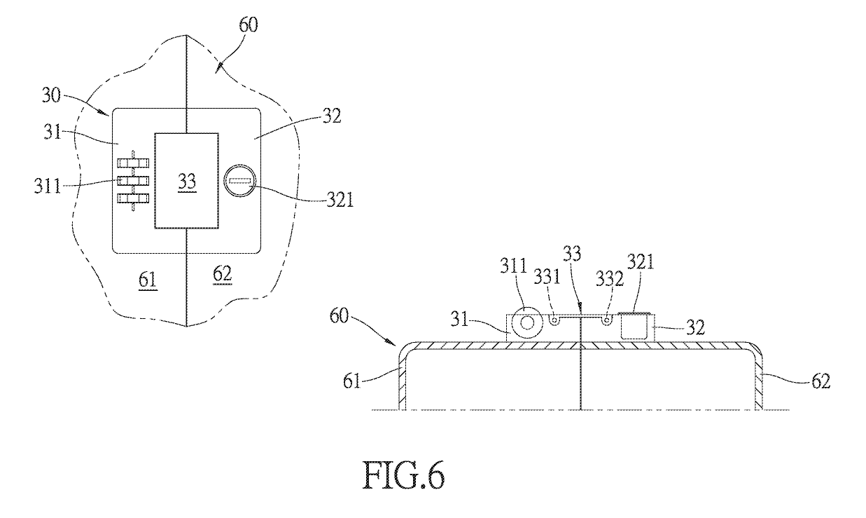

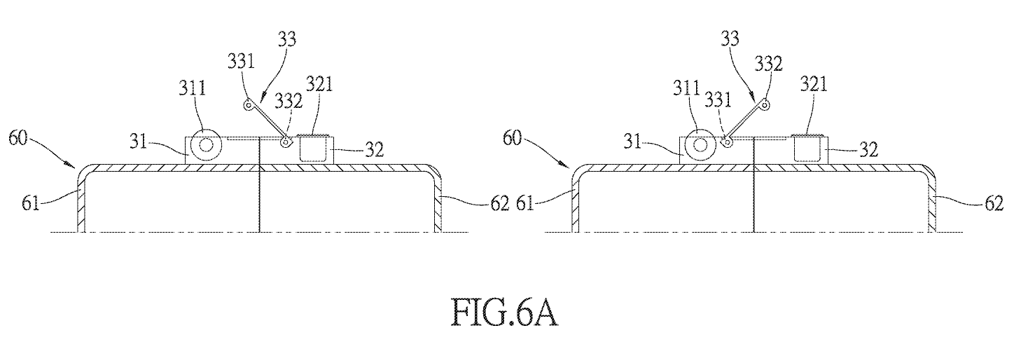

In the following description, the present invention proposes a luggage lock that can be classified into three types of lock system, FIG. 1 and FIG. 2 the first type, FIGS. 3, 4 and 5 the second type, and FIG. 6 the third type.

With reference to FIGS. 1-2, a luggage lock 10 according to a first and second embodiment of the present invention is applied to lock a luggage 60 which includes a first case body 61 and a second case body 62, the first case body 61 has a first fastener 611, and the second case body 62 has a second fastener 621, wherein the luggage 60 further includes an accommodation chamber defined wherein.

The luggage lock 10 comprises a first lock body 11 and a second lock body 12 rotatably connected with the first lock body 11; the first lock body 11 includes a first locking mechanism 111 and is detachably locked on the first case body 61 of the luggage 60; the second lock body 12 includes a second locking mechanism 121 and is detachably locked on the second case body 62 of the luggage 60.

The first locking mechanism 111 is a key lock or a combination lock; the second locking mechanism 121 is a key lock or a combination lock. In this embodiment, the first locking mechanism 111 is identical to or is different from the second locking mechanism 121.

As shown in FIGS. 1A and 2A, when the first case body 61 and the second case body 62 of the luggage 60 are located at a closed position, the first lock body 11 and the second lock body 12 locks the first case body 61 and the second case body 62 of the luggage 60 respectively at a locking position.

When the first lock body 11 is unlocked by using the first locking mechanism 111, the first case body 61 of the luggage 60 is opened so that object(s) can be taken out or placed into the luggage 60. When the second lock body 12 is unlocked by using the second locking mechanism 121, the second case body 62 of the luggage 60 is opened so that the object(s) can be taken out or placed into the luggage 60.

In other words, the luggage lock 10 comprises the first lock body 11 and the second lock body 12 rotatably connected with the first lock body 11 respectively, the first lock body 11 and the second lock body 12 are respectively locked with the first fastener 611 and the second fastener 621 at the closed position, wherein when the first lock body 11 is unlocked, the first case body 61 is opened; when the second lock body 12 is unlocked alternatively, the second case body 62 is opened.

Referring to FIGS. 3-5, a luggage lock 20 according to a third, fourth and fifth embodiment of the present invention is applied to lock a luggage 60 which includes a first case body 61 and a second case body 62, and the luggage 60 includes an accommodation chamber defined therein. The luggage lock 20 includes a first lock body 21 arranged on the first case body 61 and includes a second lock body 22 arranged on the second case body 62; the first lock body 21 has a fastener 23, and the second lock body 22 has a fixing orifice 24 fastened with the fastener 23.

The first lock body 21 further has a first locking mechanism 211, and the second lock body 22 further has a second locking mechanism 221, wherein the first locking mechanism 211 is a key lock or a combination lock; the second locking mechanism 221 is a key lock or a combination lock. In this embodiment, the first locking mechanism 211 is identical to or is different from the second locking mechanism 221.

When the first case body 61 and the second cover body 62 of the luggage 60 are located at a closed position, the first lock body 21 and the second lock body 22 are locked by ways of the fastener 23 and the fixing orifice 24 so as to lock the first case body 61 and the second case body 62, such that the first case body 61 and the second case body 62 are not opened.

As shown in FIGS. 3A, 4A, 5A, when unlocking the first locking mechanism 211 with the first lock body 21, the first case body 61 is opened so that object(s) can be taken out or placed into the luggage 60; when unlocking the second locking mechanism 221 with the second lock body 22, the first case body 62 of the luggage 60 is opened so that the object(s) can be taken out or placed into the luggage 60.

As shown in FIG. 6, a luggage lock 30 according to a sixth embodiment of the present invention is applied to lock a luggage 60 which includes a first case body 61 and a second case body 62, and the luggage 60 includes an accommodation chamber defined therein. The luggage lock 30 comprises a first lock body 31, a second lock body 32, and a connection member 33. The first lock body 31 includes a first locking mechanism 311 and is connected on the first case body 61 of the luggage 60; the second lock body 32 includes a second locking mechanism 321 and is connected on the second case body 62 of the luggage 60.

The connection member 33 has a first segment 331 locked on the first lock body 31 and has a second segment 332 locked on the second lock body 32.

The first locking mechanism 311 is a key lock or a combination lock; the second locking mechanism 321 is a key lock or a combination key. In this embodiment, the first locking mechanism 311 is identical to or is different from the second locking mechanism 321.

When the first case body 61 and the second case body 62 of the luggage 60 are locked at a closed position, the connection member 33 is locked by the first lock body 31 and the second lock body 32 by which the first case body 61 and the second case body 62 are locked.

As shown in FIG. 6A, the first segment 331 of the connection member 33 is unlocked by ways of the first locking mechanism 311 so as to open the first case body 61 of the luggage 60, such that object(s) can be taken out or placed into the luggage 60. When the second segment 332 of the connection member 33 is unlocked by ways of the second locking mechanism 321 so as to open the second case body 62 of the luggage 60, such that the object(s) can be taken out or placed into the luggage 60.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A luggage lock being applied to lock a luggage which includes a first case body and a second case body, and the luggage lock comprising:
a first lock body including a first locking mechanism and being detachably locked on the first case body of the luggage;
a second lock body including a second locking mechanism and being detachably locked on the second case body of the luggage;
wherein the first lock body and the second lock body are movably connected, when the first case body and the second case body of the luggage are located at a closed position, the first lock body and the second lock body locks the first case body and the second case body respectively at a locking position;
wherein when the first lock body is unlocked by using the first locking mechanism, the first case body is opened; when the second lock body is unlocked by using the second locking mechanism, the second case body is opened.

2. The luggage lock as claimed in claim 1, wherein the first locking mechanism is a key lock or a combination lock.

3. The luggage lock as claimed in claim 1, wherein the second locking mechanism is a key lock or a combination lock.

4. The luggage lock as claimed in claim 1, wherein the first lock body and the second lock body are rotatably connected.

5. The luggage lock as claimed in claim 1, wherein the first case body has a first fastener configured to lock with the first lock body, and the second case body has a second fastener configured to lock with the second lock body.

6. A luggage lock being applied to lock a luggage which includes a first case body and a second case body, and the luggage lock comprising:
a first lock body including a first locking mechanism and arranged on the first case body of the luggage; and
a second lock body including a second locking mechanism and arranged on the second case body;
wherein when the first case body and the second case body are located at a closed position, the first lock body and the second lock body are locked so as to lock the first case body and the second case body;
wherein when the first lock body is unlocked by using the first locking mechanism, the first case body is opened; and when the second lock body is unlocked by using the second locking mechanism, the second case body is opened.

7. The luggage lock as claimed in claim 6, wherein the first locking mechanism is a key lock or a combination lock.

8. The luggage lock as claimed in claim 6, wherein the second locking mechanism is a key lock or a combination lock.

9. The luggage lock as claimed in claim 6, wherein the first lock body has a fastener, and the second lock body has a fixing orifice fastened with the fastener.

10. A luggage lock being applied to lock a luggage which includes a first case body and a second case body, and the luggage lock comprising:
a first lock body including a first locking mechanism and arranged on the first case body of the luggage;
a second lock body including a second locking mechanism and arranged on the second case body; and
a connection member having a first segment locked on the first lock body, and the connection member having a second segment locked on the second lock body;
wherein when the first case body and the second case body are located at a closed position, the connection member is locked by the first lock body and the second lock body by which the first case body and the second case body are locked;
wherein the first segment of the connection member is unlocked by ways of the first locking mechanism so as to open the first case body;
wherein the second segment of the connection member is unlocked by ways of the second locking mechanism so as to open the second case body of the luggage.

11. The luggage lock as claimed in claim 10, wherein the first locking mechanism is a key lock or a combination lock.

12. The luggage lock as claimed in claim 10, wherein the second locking mechanism is a key lock or a combination lock.
